(19) United States
(12) Patent Application Publication
(10) Pub. No.: US 2019/0109857 A1
(43) Pub. Date: Apr. 11, 2019

(54) SECURING CLOUD DRIVES USING ENVIRONMENT-AWARE SECURITY TOKENS

(71) Applicant: Document Dynamics, LLC, Jewett City, CT (US)

(72) Inventor: Robert G. Caffary, Jr., Jewett City, CT (US)

(73) Assignee: Document Dynamics, LLC, Jewett City, CT (US)

(21) Appl. No.: 16/087,936

(22) PCT Filed: Mar. 23, 2017
(86) PCT No.: PCT/US17/23831

§ 371 Date: Sep. 24, 2018

Related U.S. Application Data
(60) Provisional application No. 62/312,618, filed on Mar. 24, 2016.

(51) Int. Cl. H04L 29/06; G06F 21/62

(52) U.S. Cl. CPC H04L 63/105; G06F 21/6209; H04W 12/002; G06F 2221/2115; G06F 2221/2111

(57) ABSTRACT

The technology described in this document can be embodied in a method that includes receiving information about an electronic file stored on a primary cloud drive of a user, and receiving one or more user-defined attributes associated with the electronic file. The one or more user-defined attributes are indicative of a home network associated with the electronic file. The method also includes generating, based on the one or more user-defined attributes, a security token that is configured to control access to the electronic file based on whether the access is from within or outside of the home network, and storing a copy of the electronic file on a secondary cloud drive separate from the primary cloud drive, wherein the copy of the electronic file is stored on the secondary cloud drive in association with the security token.

### CROSS-REFERENCE TO RELATED APPPLICATION

This application claims priority to U.S. Patent Application Ser. No. 62/312,618 entitled “Securing Cloud Drives Using Environment-Aware Security Tokens” and filed on Mar. 24, 2016, which is incorporated herein by reference in its entirety.

### TECHNICAL FIELD

This disclosure relates to security of networked devices and files.

### BACKGROUND

Security tokens for authorizing use of computer services can be generated using a security architecture such as a shared secret architecture or a public-key cryptography architecture.

### SUMMARY

In one aspect, this document features a computer implemented method that includes receiving information about an electronic file stored on a primary cloud drive of a user, and receiving one or more user-defined attributes associated with the electronic file. The one or more user-defined attributes are indicative of a home network associated with the electronic file. The method also includes generating, based on the one or more user-defined attributes, a security token that is configured to control access to the electronic file based on whether the access is from within or outside of the home network, and storing a copy of the electronic file on a secondary cloud drive separate from the primary cloud drive, wherein the copy of the electronic file is stored on the secondary cloud drive in association with the security token.

In another aspect, this disclosure includes a system that includes memory and one or more processing devices. The one or more processing devices are configured to receive information about an electronic file stored on a primary cloud drive of a user, and receive one or more user-defined attributes associated with the electronic file. The one or more user-defined attributes indicative of a home network associated with the electronic file. The one or more processing devices are further configured to generate, based on the one or more user-defined attributes, a security token that is configured to control access to the electronic file based on whether the access is from within or outside of the home network, and store a copy of the electronic file on a secondary cloud drive separate from the primary cloud drive. The copy of the electronic file is stored on the secondary cloud drive in association with the security token.

In another aspect, this document includes one or more machine-readable storage devices storing instructions that are executable by one or more processing devices to perform various operations. The operations include obtaining information about an electronic file stored on a primary cloud drive of a user, and obtaining one or more user-defined attributes associated with the electronic file. The one or more user-defined attributes are indicative of a home network associated with the electronic file. The operations also include generating, based on the one or more user-defined attributes, a security token that is configured to control access to the electronic file based on whether the access is from within or outside of the home network, and storing a copy of the electronic file on a secondary cloud drive separate from the primary cloud drive, wherein the copy of the electronic file is stored on the secondary cloud drive in association with the security token.

Implementations of the above embodiments can include one or more of the following features.

The information about the electronic file can include a user-input indicative of an intent to share the electronic file with one or more other users. The one or more user-defined attributes can include information indicative of one or more users permitted to access the copy of the electronic file. The one or more user-defined attributes can include a level of permitted access for one or more users. The level of permitted access can include a read-only access or a read-write access. The one or more user-defined attributes can include information indicative of one or more devices from which the copy of the electronic file can be accessed. Information indicative of an attempt to access the copy of the electronic file stored on the secondary cloud drive can be received, and based on the received information, it can be determined whether the attempt is from within or outside of the home network. In accordance with the determination, permission information configured to enable control of the access can be generated. Information about changes to the copy of the electronic file as a result of an attempt to access the copy of the electronic file stored on the secondary cloud drive can be received, and the changes can be presented via a user interface. The electronic file stored on the primary cloud drive can be updated upon receiving user-input indicative of an approval of the changes. The access can be determined to be from within the home network when a user profile or a device profile associated with the access is determined to be a part of the home network. The access can be determined to be from within the home network when a combination of a user profile and a device profile associated with the access is determined to be a part of the home network. Storing the copy of the electronic file in association with the security token can include initiating an encryption of the copy of the electronic file based on the security token. Storing the copy of the electronic file in association with the security token can include initiating an encapsulation of the security token with the electronic file. The encapsulation can generate an executable file. The executable file can be configured to digitally destroy at least a portion of the copy of the electronic file upon detection of an access attempt from outside the home network. The one or more user-defined attributes can be selected from a set of attributes associated with an enterprise domain within which the electronic file is stored.

In another aspect, this document features a method that includes receiving at a computing device, a device profile associated with a mobile device connected to the computing device, wherein the mobile device is connected to the computing device using a wired connection or a short-range wireless connection. The method also includes identifying, based on the device profile, that the computing device is associated with a home network of the mobile device, and is configured to access a memory location that stores a passcode for the mobile device. The method further includes retrieving the passcode for the mobile device in response to identifying that the computing device is associated with a home network of the mobile device, and unlocking the mobile device using the passcode.

In another aspect, this document features a system for unlocking a computing device such as a mobile device, the system including memory and one or more processing devices. The one or more processing devices are configured to receive a device profile associated with a mobile device connected to the computing device, wherein the mobile device is connected to a computing device using a wired connection or a short-range wireless connection. The one or more processing devices are also configured to identify, based on the device profile, that the computing device is associated with a home network of the mobile device, and is configured to access a memory location that stores a passcode for the mobile device. The one or more processing devices are further configured to retrieve the passcode for the mobile device in response to identifying that the computing device is associated with a home network of the mobile device, and unlock the mobile device using the passcode.

In another aspect, this document features one or more machine-readable storage devices storing instructions that are executable by one or more processing devices to perform various operations. The operations include obtaining a device profile associated with a mobile device connected to the computing device, wherein the mobile device is connected to the computing device using a wired connection or a short-range wireless connection. The operations also include identifying, based on the device profile, that the computing device is associated with a home network of the mobile device, and is configured to access a memory location that stores a passcode for the mobile device. The operations further include retrieving the passcode for the mobile device in response to identifying that the computing device is associated with a home network of the mobile device, and unlocking the mobile device using the passcode.

Implementations of the above aspects can include one or more of the following features.

The short-range wireless connection can include a connection established using at least one of: a near-field communication protocol, a Bluetooth protocol, or a radio frequency identification protocol. The computing device can receive from the mobile device, registration information that includes the device profile associated with the mobile device. User-permission to include the computing device in the home network of the mobile device can be obtained, and a passcode associated with the mobile device can be generated based at least on the device profile. The passcode can be usable for unlocking the mobile device. The passcode for the mobile device can be stored at the memory location in association with the device profile of the mobile device. Information representing a change to the passcode can be received from the mobile device, and the stored passcode can be updated in accordance with the received information.

In some implementations, the technology described in this document may provide one or more of the following advantages. A file stored in a primary cloud drive may be securely protected from unauthorized changes by providing a copy of the file in a secondary cloud drive for sharing and/or collaboration purposes. Any changes made to the copy may be merged with the master file in the primary cloud drive only upon the changes being authorized by a user of the primary cloud drive. In addition, environment-aware security tokens may be used to prevent unauthorized access attempts from user-profiles and/or devices determined to be outside of a home network associated with the file. One or more security tokens for the file may be generated based on various user-defined attributes that govern accessibility criteria for the file. Therefore, the technology described herein may allow the owner of a file (e.g., the user of the primary cloud drive) to control, at least to some extent, the security and encryption associated with the accessibility of the file. The technology can also be used in enterprise scenarios, where enterprise administrators may delegate the user-defined attributes, which in turn are selected by the enterprise users for generating security tokens for their documents.

Other features and advantages are apparent from the following detailed description, and from the claims.

### BRIEF DESCRIPTION OF THE DRAWINGS

FIG. 1 is an example of a system that uses environment-aware security tokens.

FIG. 2A is an example organization of multiple cloud drives.

FIG. 2B is an example of a user interface that can be used for setting attributes of an electronic file stored on a cloud drive.

FIG. 3A is a flowchart depicting an example sequence of operations for securing electronic files stored in cloud drives.

FIG. 3B is a flow chart depicting an example sequence of operations for unlocking a mobile device.

FIG. 4 is a diagram illustrating examples of computing devices.

### DETAILED DESCRIPTION

The advent of cloud computing has allowed for leveraging the computing power and storage capacity of massively distributed systems and/or cluster-aware systems. Users of a cloud computing system may outsource their computation and/or storage needs to the cloud computing system, thus reducing the need for hardware on the users' devices. Such cloud computing systems may be implemented, for example, using large-scale Internet services and/or massively parallel computing infrastructure provided by warehouse-sized computing systems, e.g., data center facilities. Such data centers may be made up of hundreds, thousands, or tens of thousands or more of computing nodes, their associated storage devices, and interconnection infrastructure. As such, the terms “cloud-based system” or “cloud computing system,” as used throughout this document, includes remote computing resources (hardware, operating system, and/or software) the use of which can be delivered, for example, as a service over a network such as the Internet. The term “cloud drive,” as used in this document, includes remote storage locations that are accessible by a user device over a network such as the Internet.

The demand for cloud drives has increased with the massive increase in the amount of data created and used by users. In many cases, the amount of data “owned” by a user is significantly more than the storage capacity of the corresponding user devices. This is also often true for corporations, which continue to turn to cloud-based storage, for example, to avoid significant costs associated with buying and maintaining massive storage systems. However, allowing personal and corporate data (which often includes sensitive information) to be stored in remote third-party storage locations have also given rise to concerns associated with the security of such data. While data stored in cloud drives may be protected using security mechanisms such as secure single sign-on or a shared secret or public-key cryptography, such mechanisms may be vulnerable to threats based on duplication of underlying cryptographic material. For example, a malicious entity (e.g., a human user such as a hacker, or software entities such as a computer virus or other malicious software) may breach the security of a cloud storage systems to steal data in the form of documents or other files. In such cases, the stolen files may be stored on a storage device conveniently accessible to the malicious entity, and content of the files may potentially be used in illegal or harmful activities. This may happen, for example, when a malicious entity attacks a financial institution such as a credit card company and is able to copy files that include sensitive user information such as username and password pairs. The sensitive information can then be supplied to a token generating authority (e.g., a secure website) to obtain the security tokens needed for accessing, for example, user accounts.

The risk of unauthorized accessing and/or copying of files from cloud drives may be reduced by encrypting files with environment-aware security tokens that lock down the files to a home network defined for the files. In such cases, the files may only be accessed from within the home network (e.g., as defined by a pre-determined set of user-profiles and/or devices). Any access attempt from outside the home network (e.g., an attempt to open the file after being copied to a device that is not within the home network) may be prevented, for example, either by digitally shredding the file or otherwise preventing access to the content of the file. U.S. Published Application 2016/0044040 (the content of which is incorporated herein by reference) described improving security of network assets (documents, files, devices etc.) by generating environment-aware security tokens that are specific to the corresponding assets.

The technology described in this document includes, for example, using the environment-aware security tokens in securing assets stored on cloud drives. For example, a security token generated for a file stored on a cloud drive can be configured based on one or more user-defined attributes such that the user has control over the security, encryption, and/or accessibility of the file. In some implementations, the user-defined attributes can be used to lock-down the file to a home network, e.g., as defined based on a predetermined set of user-profiles and/or devices, such that the corresponding security token thwarts any access attempt from outside of the home network. In addition, if a user intends to share a file that is stored in the user's cloud drive, a copy of the file is stored in a secondary cloud drive that other authorized users may access. If a particular file is shared with read-write permissions (e.g., for collaborative purposes), any changes made to the copy of the file stored in the secondary cloud drive is not merged with the master copy stored in the primary cloud drive unless the user of the primary cloud drive approves of the changes. This may provide the user with a flexible tool for controlling access to his/her files, while also reducing the chances of accidental or unauthorized changes to the master copy of the file. Such multi-layer security may allow for a robustly secure system for sharing files stored on massively distributed storage systems such as cloud drives.

While this document refers primarily to electronic documents, the technologies described herein may be extended for various types of network assets. Network assets can include, for example, devices that are directly or indirectly associated with a network, electronic files that can be stored on a device associated with the network, as well as user/device profiles associated with the network. For example, network assets can include a personal computing device (e.g., a laptop computer), a printer, a desktop computing device, a mobile device (e.g., a smartphone, tablet or e-reader), a storage device, server, or another network device. In some implementations, the assets can include a passive device such as a credit or debit card or a radio frequency identification (RFID) tag that can communicate over the network via an appropriate reader (e.g., a credit/debit card reader and RFID tag reader, respectively). In some implementations, the home network for a network asset can be specific to that particular asset. For example, an owner of an electronic file can define a home network for the file by specifying users and/or devices that may access the file, and/or storage locations (e.g., cloud drives) on which the file can reside. In another example, the home network for a particular device may be defined by specifying the user profiles that are allowed to access the devices. In some implementations, two different assets associated with a network may have different home networks. In some implementations, the home networks for two or more network assets may be substantially identical to one another. Because a home network may be specified or defined for individual network assets (or groups of network assets), the home network may also be referred to as an asset-specific home network or simply an asset-specific network.

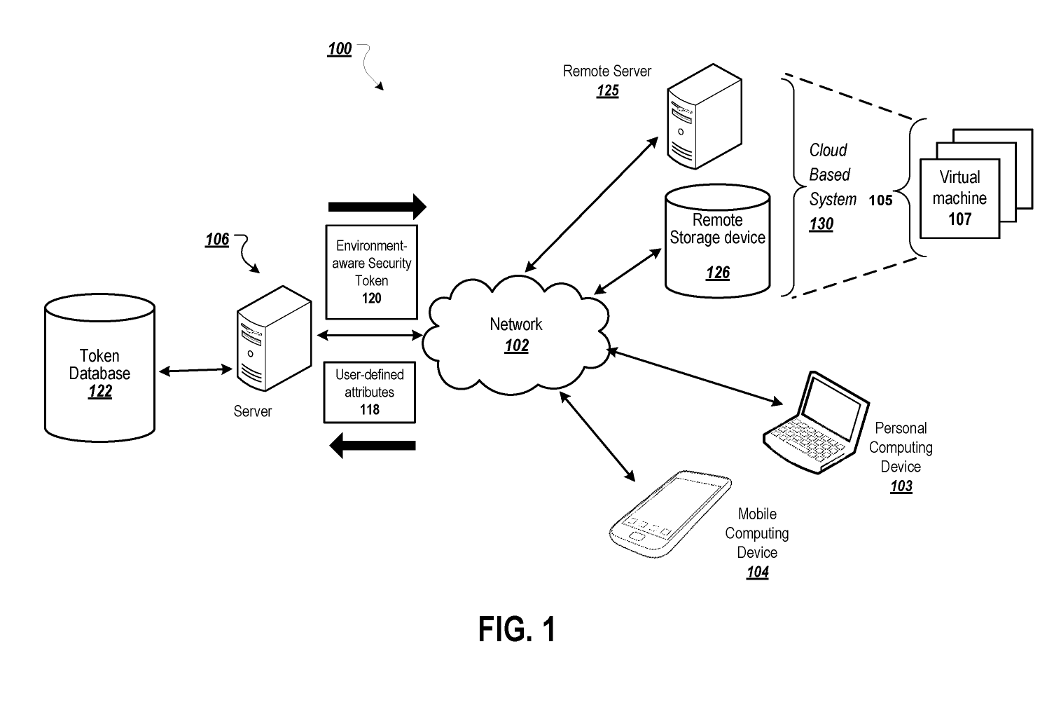

FIG. 1 shows an example of a cloud based system 100 that uses environment-aware security tokens. The system 100 includes various user devices (e.g., a personal computing device 103 and a mobile computing device 104) connected over a network 102 to a remote server 125 and a remote storage device 126. The remote server 125 and/or the remote storage device 126 can be part of a distributed computing system (which may be referred to as a cloud computing system or a cloud-based system) that provides cloud-based services to the connected user devices. For example, the remote server 125 and/or the storage device 116 may be used to generate a pool 105 of multiple virtual machines 107 usable by the user devices. A virtual machine 107 can be a set of computing resources (processors, memory, software etc.) that can be used for executing tasks originating from the user devices. For example, a virtual machine 107 can include storage space that can be accessed from a user device to store electronic files. Such storage space may be physically located on the remote storage device 126, and accessible by the user devices via the network 102 (which may include, e.g., the Internet). In some cases, storing on such remote storage devices is referred to as storing on a cloud drive. A particular cloud drive may be made user-specific such that a primary user can use the cloud drive as his/her own personal storage device. The primary user may be referred to as an owner of such a cloud drive, as well as of the electronic files stored in the cloud drive. In some cases, one or more cloud drives may also be associated with a particular corporation, institution, or other establishment. In some cases, the cloud drives may be used in an enterprise setting where one or more administrative agents of the corporation, institution, or establishment may be referred to as owners of the cloud drives.

Storing data on cloud drives hosted on remote storage devices 126 may allow easy sharing of data with multiple users. For example, a user may allow friends and families to access the user's cloud drive over the Internet to view photos or other documents. This facilitates sharing of large volumes of data with one or more users without having to send the data over email or portable storage devices. However, hosting cloud drives on remote storage devices may require implementation of various security mechanisms such as cryptography techniques to prevent non-permissive access to a user's data. Even when another user or entity is permitted to access a file stored on a cloud drive, the permitted user or entity may modify a file, possibly unknowingly, in an undesired way, or even accidentally delete the file. In addition, files copied from a cloud drive and stored in another storage location could potentially result in the content of the files being used in illegal or harmful activities.

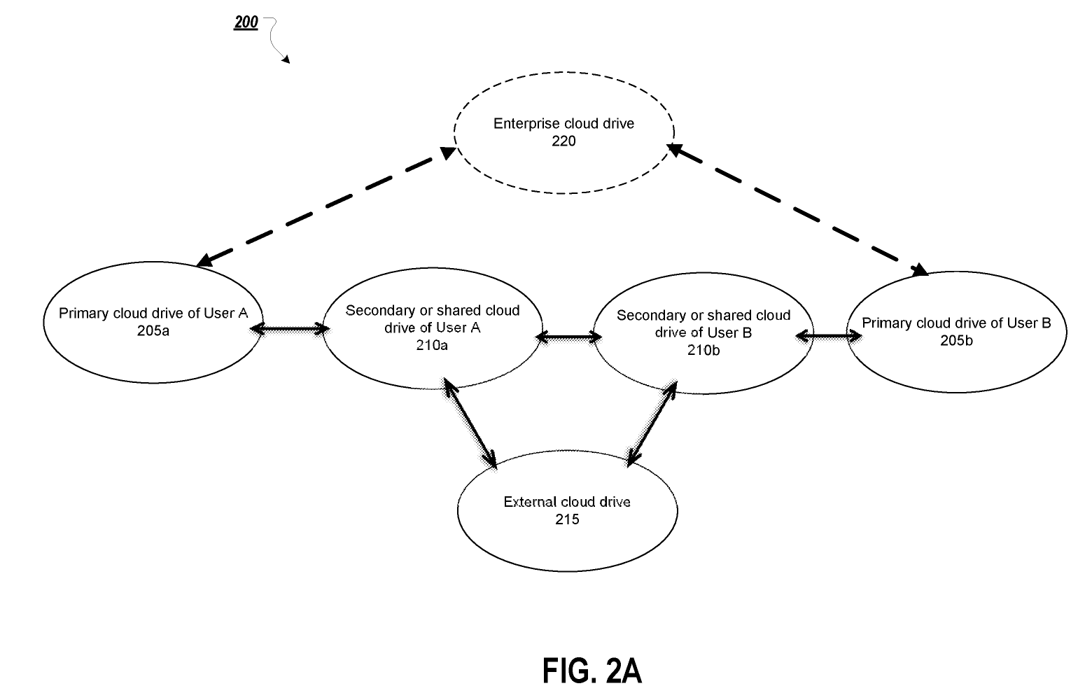

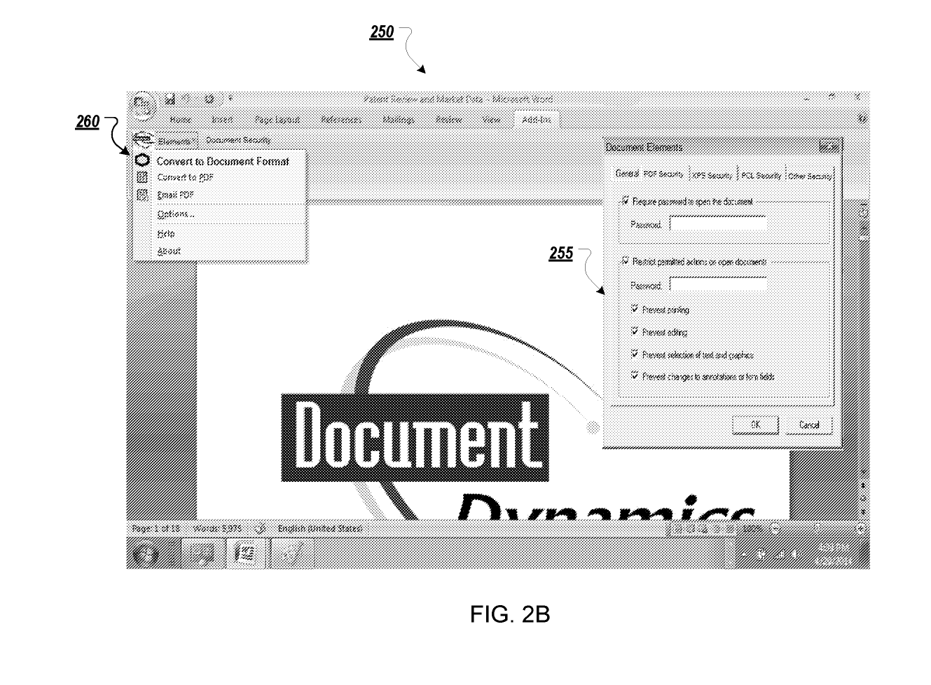

The security of a file stored on hosted cloud drives can be increased, for example, by copying the file to a secondary storage location (e.g., a secondary cloud drive) for sharing and collaborative purposes. This is illustrated by way of an example in FIG. 2A, which shows a schematic diagram representing an example organization 200 of multiple cloud drives. In particular, the example of FIG. 2A shows primary cloud drives 205a and 205b (205, in general) for a first user (User A) and a second user (User B), respectively. Secondary cloud drives 210a and 210b (210, in general) are also hosted for the first and second user, respectively, to facilitate sharing or collaboration of files. For example, if a user intends to share a file stored on the primary cloud drive 205, a copy of the file is copied or mirrored in the corresponding secondary cloud drive 210 for the sharing. Other users (e.g., users that the file is being shared with) are granted access (e.g., read-only or read/write access, specified, for example, by the sharing user via a user-defined attribute) to the copy of the file stored on the secondary cloud drive 210. In some implementations, changes made to the copy of the file on a secondary cloud drive 210 may be merged with the copy of the file on the corresponding primary cloud drive 205, but such merging may be done only upon receiving an approval to do so. In some cases, the changes may be presented to the user of the primary cloud drive, for example, via a user-interface, and merged with the copy of the file in the primary cloud drive upon receiving approval from the user. This way, the copy stored on the primary cloud drive 205 may be made immune to accidental changes or deletions resulting from sharing of the file.

In some implementations, a user may allow others to store/save files on the user's secondary drive 210. For example, subject to the user's permission, files from one or more external cloud drives 215 may be stored on the user's secondary cloud drive 210. The user may then review such files before allowing the files to be saved on to the user's primary cloud drive 205. In some implementations, this may allow secure vetting of files before allowing the files to be stored on a primary cloud drive, thereby increasing the security of the primary cloud drive.

In some implementations, the copies stored on the primary and/or the secondary cloud drives may be associated with corresponding environment-aware security tokens such that the files are locked down to the cloud drives or home networks on which they reside. Therefore, even if the file is copied from a cloud drive to an unauthorized device (e.g., a device that is not a part of the home network defined for the file), access to the content of the file may be prevented upon detection of a dissociation from the home network. For example, when a file is stored on a secondary cloud drive 210, the sharing user may specify one or more user-defined attributes to control access to the file. For example, the sharing user can specify who can access the file (e.g., as identified by one or more user profiles), a list of one or more devices from which the file may be accessed (e.g., as identified by device profiles), and the type of access (e.g., read only or read/write) allowed for different combinations of device and user profiles. A security token for the file can be generated based on the user-defined attributes, thereby providing the user with control over the encryption of the files stored in the secondary cloud drive 210. In some implementations, security tokens can also be generated for the copies of the files stored in the primary cloud drives to lock down such copies to the primary cloud drives. In some implementations, generating a security token for a file stored in a secondary cloud drive 210 can include modifying a security token of the corresponding copy of the file stored in the primary cloud drive.

In some implementation, a user may generate, based on one or more user-defined attributes, their own exclusive private key for encrypting their private data and devices. For example, such an exclusive private key can be used to encrypt various physical and virtual assets such as documents, devices, device serial numbers and memory storage locations. In some implementations, a remote server (e.g., the token server 106) also generates a exclusive proprietary key together with the exclusive private key, and securely stores both keys (e.g., in a secure memory location, which may also be disconnected from external networks to reduce chances of being breached). Various user-specific data such as user profiles, software applications, documents, devices and memory locations are registered to a particular user, and associated with the generated keys. Because the exclusive private key and exclusive proprietary key are unique to a particular user, they cannot be used to access decrypt anyone else's assets.

In some implementations, each hosted cloud drive associated with a user can therefore be configured as a private network, which, under an enterprise domain, may be linked to one or more administrator accounts. Once the user (e.g., an employee of the company administering the enterprise domain) logs in to the enterprise domain, the administrators may be able to manage the user's cloud drives that are associated with the enterprise domain. Such a user-centric cloud drive solution may allow a business to administer secure private networks without investing in expensive network server hardware. In some implementation, cloud drives 220 hosted under an enterprise domain may be used to mirror cloud drives associated with individual employees or agents. The mirroring or copying of content from the users' cloud drives 205 to the enterprise cloud drives 220 may be subject to approval from the administrators. This may also be extended, for example, to third-parties that engage with the enterprise domain, for example, to control undesirable content from the third parties to infiltrate the enterprise network. For example, if a company allows third-parties to upload electronic files (e.g., applications developed by the third-parties), the third parties may be asked to upload their files to a secondary cloud drive. The files may be allowed to be mirrored or copied onto the enterprise cloud drives upon satisfying one or more criteria set by the enterprise administrators. This may facilitate, for example, a reduction in an amount of malicious electronic files (e.g., malware, virus etc.) that could infiltrate an enterprise network, and allow administrators to potentially identify third parties violating security criteria set by the company. In some implementations, a user's primary cloud drive or secondary cloud drive can be mirrored on the enterprise cloud drive 220 using a key (also referred to as an enterprise key) generated for the corresponding enterprise.

In some implementations, keys generated for a particular user and/or network assets (e.g., electronic files, devices, etc.) of a particular user can be used for controlling access to one or more devices, memory locations (e.g., cloud drives), or other network assets associated with the home network of a user. For example, access can be granted based on two or more separate keys. For example, a security server may generate an access key and a system key for granting access to a particular network asset such as an electronic file or device. In some implementations, the access key may be specific to the source of the access, including for example, a user (in which case the access key can be referred to as a user key) or a device (in which case the access key can be referred to as a device key), and the system key can be specific to the destination of the access. For example, the system key can be specific to a particular device or memory location such as the secondary cloud drive 210. In another example, the system key can be specific to an electronic network asset such as a file or document. The system key may also be specific to one or more of, for example: a security token, a domain, or an enterprise network. In some implementations, the system key or the access key may be used to encode one or more security policies associated with access to the corresponding asset.

In some implementations, access to a particular network asset such as a device (e.g., a cloud drive) or an electronic file (e.g., a file stored on a cloud drive) may be controlled based on both keys. For example, if User A intends to grant User B access to the secondary cloud drive 210a, User A may share an access key (e.g., the device key) associated with the secondary cloud drive 210a, for example, by providing a link to the secondary cloud drive 210a. In response to receiving an indication of the sharing of the access key, a server administering the access (e.g., a token server, as described below) may then automatically generate a specific system key (e.g., a key specific to the user profile associated with User B) and provide the system key to User B. In some implementations, the system key may encode permission information (e.g., security policies such as whether read-only or read-write access is permitted, or what device may be used) associated with the access. In some implementations, User A may provide a system key to User B, and the token server may generate the access key for User B.

In some implementations, User B may be able to access the secondary cloud drive 210a upon satisfying an authentication process that uses both keys. Because the system key can be configured for a specific user, device, time period etc., access to a network asset (e.g., a secondary cloud drive 210) by a malicious entity may be prevented even if the malicious entity somehow obtains the access key corresponding to the network asset. Security for private network assets or storage locations (e.g., a primary cloud drive 205) can be provided, for example, by generating corresponding system keys that are specific to a user-profile of the corresponding owner of the asset, and/or specific to one or more devices associated with the owner. Therefore, by using the technology described herein, a particular user may act as a gatekeeper of network assets owned by the particular user. Access to network assets can therefore be made user-centric, scalable and secure.

The phrase “electronic files” or “files,” as used in this document, can include any collection of electronic information that can be stored, accessed, read, processed, or otherwise acted on by a device, such as one or more of the devices connected by the network 102. The files can include, for example, documents, software packages (e.g., applications), executable files, binary files, non-binary files, or other files that can be stored or processed electronically. The files can be associated with various applications and include various features. For example, the files can include word processing documents, spreadsheets, text files, drawing files, data files (e.g., database files, and/or information), and multimedia files (e.g., audio, video, system data files etc.). The files can be formatted in accordance with an application and/or operating system associated with individual files. The formats of the files can be identified, for example, by an appropriate file name extension such as .exe (for executable files), .htm (for hypertext markup language (HTML) files), or .txt (for text files). In some implementations, the electronic files can include various types of records and files stored in different types of databases. For example, the electronic files can include medical records, academic records, health records, business records, government records, criminal records, real-estate records, financial records, social network data etc. The electronic files can be stored, for example, on a single device (e.g., a laptop computer or server), or can be distributed across several devices (e.g., multiple servers, multiple trays in a data center, or multiple virtual machines in a distributed computing/storage system such as a cloud-based system).

In some implementations, the electronic files include metadata information about the corresponding files. The metadata can include, for example, structural metadata that relates to design and specification of data structures, and descriptive metadata that relates to additional information the data content. The metadata can include, for example, information on a location of creation of the document, means of creation of the document, time and date of creation of the document, author or source of the document or the data within the document, and security policies associated with the document. In some implementations, the metadata information about a particular document (or an electronic file, in general) can include, for example, one or more user-defined attributes for the document or file that may be used in generating an appropriate environment-aware security token for the particular document. One or more user-defined attributes used in generating a security token can be provided by the “owner” of the file, or, within enterprise domains, by an administrator of the enterprise domain. For example, user-defined attributes associated with an electronic file may establish that the corresponding document can only be viewed by personnel from the Human Resources department of a company. In such cases, the corresponding environment-aware security token for the file can be configured such that the content of the file is viewable (and/or printable) only on devices associated with the Human Resources department.

Referring back to FIG. 1, the system 100 can include a server 106 that coordinates generation, distribution, and/or validation of environment-aware security tokens 120. The server 106 may also be referred to as a security token server or simply a token server. In some implementations, the server 106 receives one or more user-defined attributes 118 associated with an electronic file, and generates the corresponding one or more environment-aware security tokens 120. Even though FIG. 1 shows a single server 106, multiple servers (e.g., a server farm), and/or one or more remote servers 125 can be used for implementing the functionalities of the server 106. The server 106 can be a dedicated server, or the functionalities of the server 106 can be provided by a server that performs other tasks.

The user-defined attributes 118 can include various identification information associated with an electronic file and access thereof. For example, the user-defined attributes can include one or more of: a serial number of a device, a media access control (MAC) address, a file path, a registry key, a network identifier, an internet protocol (IP) address, a file-type identifier, a file attribute (e.g., read-only, read-write, etc.), a user-profile identifier, globally unique identifiers (GUIDs), universally unique identifiers (UUIDs) or other information that may be used to identify a home network for an electronic file. In some implementations, the home network may be defined by the serial numbers or MAC addresses of a group of physical devices, such as the devices owned, administered, or otherwise controlled under an enterprise domain by a company or institution. In some implementations, the user-defined attributes 118 can include identification of electronic files and documents and/or the corresponding storage locations on various devices associated with the home network. In some implementations, the user-defined attributes 118 can include user profile information that identifies one or more users authorized to access files associated with the home network.

In some implementations, the user-defined attributes 118 can also include various security policies related to the usage of the corresponding electronic files. For example, the user-defined attributes 118 can include, for example, an identification of devices or profiles of users (also referred to herein as user profiles) authorized to access a particular electronic file. In some implementations, the user profiles and/or device profiles authorized to access a file stored in a cloud drive (e.g., a secondary cloud drive 210) can be specified by an owner of the cloud drive. Under an enterprise domain, at least a portion of the user-defined attributes may be specified by an administrator of the enterprise domain. For example, one or more user-defined attributes provided by an administrator of an enterprise domain may specify that a particular document is viewable only by the board of directors. In such a case, the environment-aware security token for the particular document can be configured such that the document can be viewed only when accessed from a user-profile and/or device profile associated with a member of the board of directors.

The server 106 can be configured to corresponding environment-aware security tokens 120 for electronic files stored on cloud drives, based on at least a portion of the user-defined attributes 118. The generated environment-aware security token 120 can be configured to control how and/or by who the corresponding file may be accessed. Once an environment-aware security token 120 is generated and linked to a particular file, the file may be used only in accordance with the security policies encrypted within the environment-aware security token 120. For example, the environment-aware security token 120 for a document or file can be configured such that the document is accessible only on a selected set of devices (identified, for example, using serial numbers or MAC addresses) and/or via a user profile from an approved set.

In some implementations, security policies may be implemented using security threads. In some implementations, a security thread may support multiple paths of execution for an application or file. For example, when multiple programs run concurrently, the operating system may allocate execution time to each program based on the requirements of the program and that of other programs or files. In some implementations, security threads can include permission processes that are managed by the token server using digital rights management (DRM), and/or enterprise or user group policy privileges. In some implementations, security threads may be used to manage text based security keys. In some implementations, the token server 106 can be configured to generate and manage security tokens from security threads that become security objects attached to particular identifiers such as GUID and UUID assigned by the token server. In some implementations, the token server 106 can be configured to generate, from a security thread, security tokens that are set as file attributes used by the file management system of the operating system.

In some implementations, the environment-aware security token for a file can be generated based on a selectable portion of the user-defined attributes 118. For example, an administrator of the enterprise domain may specify a set of user-defined attributes that an individual user (e.g., an employee) may select from in order to have a security token generated for an electronic file. By allowing such configuration of the environment-aware security tokens, the technology described in this document can be made scalable, granular, and flexible to suit various types of security applications. As a result, users can be provided with local control over encryption of files (e.g., ability to specify who can access a file stored in a cloud drive, and assign different levels of authorization), while maintaining a global control over security options (e.g., for all users in an enterprise domain).

A security token generated by the token server 106 based on the user-defined attributes or user defined document elements may be associated with an electronic file in various ways. In some implementations, the environment-aware security token 120 may be integrated into the corresponding file. For example, if the electronic file is a document, the environment-aware security token may be embedded into a page description language (PDL) of the document. Examples of PDLs include PostScript, Printer Command Language (PCL), Portable Document Format (PDF), and mark up languages such as Open XML Paper Specification (XPS) and Hypertext Markup Language (HTML). In some implementations, the environment-aware security tokens may be associated with an electronic document using, for example, a software application, device, or robotic software agent that has the ability to generate a document. Examples of the documents can include a word processing document, a spreadsheet document, or a presentation document. The documents can be generated using, for example, a robotic browser or browser script, or a robotic software agent or file management system running under an operation system. In some implementations, such embedding (e.g., of security objects and/or file attributes) may be performed, for example, by a document agent engine of an operating system associated with the cloud based system 130 on which the cloud drives are hosted.

In some implementations, the document agent engine may provide one or more software package-specific plug-ins or add-ins (also referred to herein as document agents) that are installed on devices associated with the home network. FIG. 2B shows an example user interface 250 where such a document agent is installed into the word processing application (MICROSOFT WORD in this particular example). Such a document agent may allow a user to perform various configurations on a document, for example, to make the document compatible with environment-aware security tokens, and/or specify security parameters of the document. For example, the document agent may allow, for example via a second user interface 255, to specify whether a password would be required to access the document, or if one or more actions (e.g., printing, editing, copying etc.) should be restricted. In some implementations, the user interface 255 can be configured to allow a user to specify user-defined security parameters such as cypher keys or passwords to a document, such that the document had additional protection, for example, against unauthorized internal access (i.e., access associated with devices or user-profiles associated with the home network). In some implementations, the document agent can also be configured to integrate the received environment-aware security token 120 into the corresponding document. For example, the document agent can be configured to embed the received environment-aware security token into the page description language (PDL) of a document. In some implementations, an environment-aware security token may be embedded into the header portion of a document via a process such as code injection (implemented, for example, using a programming language such as JAVA). This can be done, for example, by providing the token server, or an automated browser, appropriate permissions to modify document attributes. Such permissions can be configured or modified based on the security context and group policies associated with the home network.

In some implementations, the environment-aware security token may be encapsulated with the corresponding file to create, for example, an executable file. Such an executable file can be configured to verify that an access attempt on the file originates from within the home network before an access to the encapsulated document is allowed. Upon determining that the file is being accessed from a location outside the home network (or at an otherwise unauthorized device or storage location), access to the encapsulated document can be prevented. In some implementations (such as for high security applications), any unauthorized attempt to access the file can cause a destruction (e.g., by deletion or digital shredding) of the content of the encapsulated document. In some implementations, an unauthorized attempt may be detected, for example, when the executable file, upon being invoked, fails to establish a connection with a token server that controls administration of the security objects. In some implementations, the executable file can also be configured to collect information on one or more metrics associated with the environment from where an access attempt is being made. For example, in the event of a security breach (e.g., a hack), the entity can be configured to transmit details of the environment (e.g., MAC address, IP address, device serial number etc.) back to the token server.

In some implementations, the environment-aware security token 120 for a file can be configured such that the file may be viewed or accessed from outside the home network, but no changes or edits to the electronic file may be made. This can be useful, for example, in a social network, where user data (e.g., social network account) stored on a cloud drive is protected using one or more security tokens 120. The user-defined attributes 118 specified for the one or more security tokens can include identification of a plurality of devices (e.g., home computer, office computer, and personal mobile devices) that the user plans to use in accessing the social network account. The security tokens 120 generated based on the user-defined attributes can be configured such that the social network account can be updated (e.g., via posts, images, videos, or changes to account profile) only from the devices that are associated with the user profile. This way even if the security of the account is compromised (e.g., via a phishing attack that obtains the username-password pair for the user account), a malicious entity (e.g., a hacker) in possession of the account credentials may be prevented from making any changes to the user account from devices that are not identified in the security token associated with the social network account. For example, the malicious entity would not be able to post potentially embarrassing or harmful content to the user's account in spite of obtaining the credentials needed to log into the user's account. Security of other web-based accounts such as e-mail accounts, online banking accounts, trading accounts, and e-commerce accounts can therefore be increased by using environment-aware security tokens 120 generated based on user-defined attributes that identify a predetermined set of physical devices with the corresponding accounts.

In some implementations, the server 106 can be configured to generate the environment-aware security tokens 120 as language agnostic objects that can be developed using various programming languages capable of accessing and processing binary data types such as the ones associated with the user-defined attributes 118. For example, the environment-aware security tokens 120 can be implemented as objects generated using the Component Object Model (COM) standard that is a binary-interface standard for software components developed by MICROSOFT. The standard can be used, for example, to enable inter-process communications and dynamic object creation in a large range of programming languages. In some implementations, language agnostic objects such as COM objects allow reuse of objects with no knowledge of the corresponding internal implementation. For example, the objects may be implemented using interfaces that are agnostic to the implementation details. Different allocation semantics of various programming languages can be accommodated, for example, by making objects responsible for their own creation and destruction through processes such as reference-counting. Reference counting can be used, for example, as a technique of storing the number of references, pointers, or handles to a resource such as an object, block of memory, disk space or other resource. Casting between different interfaces of an object can be achieved, for example using query processes such as the QueryInterface.

In some implementations, the server 106 is configured to generate the environment-aware security tokens 120 for corresponding electronic files as objects (e.g., COM objects) using at least portion of the user-defined attributes 118. For example, an object corresponding to an environment-aware security token can include data fields corresponding to the portions of the user-defined attributes used in generating the environment-aware security token, and procedures associated with intended functionalities of the environment-aware security token.

In an object-oriented programming paradigm, the procedures associated with the functionalities may be referred to as methods. In some implementations, the methods associated with an object corresponding to an environment-aware security token can be related to, for example, one or more of the following functionalities: i) detecting environmental parameters for a file associated with the environment-aware security token, ii) authenticating the file with a token server (e.g., server 106), iii) allowing access to the file upon authentication, iv) preventing access to the file upon detecting a dissociation from the home network, and/or v) tracking various activities related to accessing the electronic file.

The environment-aware security token 120 embedded or otherwise integrated with an electronic file can be configured to detect environmental parameters associated with an access. For example, if the environment-aware security token 120 is embedded into document metadata, or metafile, the associated object (e.g., COM object or other security object) can be configured to detect a serial number of the device that the document is being accessed from or stored on. The environment-aware security token 120 can be configured to detect one or more other environmental parameters such as user-profile information, security policies associated with the document, a type of access being attempted on the document, etc.

The environment-aware security token 120 of an electronic file can also be configured to attempt an authentication of the electronic file (or an access attempt on the electronic file) using the detected environmental parameters. For example, when a user attempts to access an electronic file stored on a cloud drive, the environment-aware security token 120 can be configured to detect the environmental parameters associated with the access attempt (e.g., user profile, device profile, whether the file is located on the cloud drive or elsewhere etc.) and communicate the detected environmental parameters to the server 106. In response, the server 106 may provide an indication if access to the electronic file can be allowed. The server 106 may make the determination, for example, by comparing the received environmental parameters with those stored for the corresponding security token in a token database 122. Alternatively, the environment-aware security token may also perform at least a portion of the authentication locally, for example, based on information (e.g., an identification of a corresponding home network) encrypted within the environment-aware security token 120. If a connection to the server 106 cannot be established (for example, due to loss in Internet connectivity), a message may be displayed notifying the user that the electronic file cannot be accessed immediately. In some implementations, the authentication can be triggered when an attempt to access the corresponding electronic file is made (e.g., when a user attempts to open a document). The environment-aware security token 120 can also be configured to be synchronized with the server 106 periodically, for example, after predetermined time intervals or when any changes to the corresponding electronic file is detected.

In some implementations, upon determining that an access to the corresponding electronic file may be allowed, the environment-aware security token 120 can allow access to the corresponding electronic file. For example, upon determining that an authorized user is attempting to open a document (as indicated, for example, by authentication information received from the server 106), the environment-aware security token 120 can allow the user to access the document. The access may be allowed based on additional security policies associated with the document. For example, the environment-aware security token 120 may allow a read-only access to a document based on determining that the user attempting to access the document is not authorized to edit the document.

On the other hand, if the environment-aware security token 120 determines that an access to the electronic file is unauthorized, the access may be prevented. For example, if the environment-aware security token 120 determines that a corresponding document is residing on a device that is not authenticated to the home network, access to the content of the document may be denied. In high security scenarios (e.g., for confidential or sensitive military or healthcare related documents), the environment-aware security token 120 can be configured to destroy, delete or digitally shred the corresponding document upon detecting unauthorized access attempts. In some implementation, the environment-aware security token 120 associated with an electronic file can be configured to log access information (e.g., creation credentials, time and nature of access attempts, location of access attempts, device ids, etc.) for the corresponding electronic file. The access information can be stored, for example, on a local storage device within an encrypted file system. The stored access information can then be synchronized with information stored at the server 106 during subsequent communications between the environment-aware security token 120 and the server 106. In some implementations, a separate agent such as a virtual private network (VPN) agent can be used to communicate the access information to the server 106. Such an agent may itself be associated with a corresponding environment-aware security token 120, and may use database management systems such as MySQL, ORACLE, or MICROSOFT SQL to manage communications with the server 106. In some implementations, the access information may also be used to update the environment-aware security token 120 associated with the document. The environment-aware security tokens 120 can therefore be used to generate and maintain an audit trail of electronic file usage, thereby further increasing security and accountability of electronic file usage. In some implementations, the access information corresponding to a file stored on a secondary cloud drive 210 can be presented to a user associated with the corresponding primary cloud drive (e.g., via a user interface). In some cases, presentation of such information may allow a user to decide whether to allow changes to the secondary cloud drive copy to be merged with the copy stored in the primary cloud drive.

In some implementations, the environment-aware security tokens 120 generated by the server 106 is stored within the token database 122 accessible to the server 106. The token database 122 may be stored in a storage device within the server 106 or at a remote storage location accessible to the server 106. The token database 122 can be used to store information about the environment-aware security tokens 120 generated at the server 106. For example, the token database 122 may store information linking the environment-aware security tokens 120 to the corresponding electronic file identifiers such as the GUIDs or UUIDs. The information linking the environment-aware security tokens 120 to the corresponding identifiers can be used, for example to identify home networks associated with the corresponding electronic files, and/or to authenticate access attempts on the various electronic files. For example, if a user attempts to access a document from a particular device, the server 106 may authenticate the access attempt based on information linking a corresponding environment-aware security token 120 to the identifier associated with the document. In some implementations, the token database 122 also stores access information associated with the corresponding electronic files. For example, if an electronic file (such as a document) is updated, modified, created, deleted, or otherwise acted on, such access information can be stored in the token database linked, for example, to the corresponding electronic file identifiers.

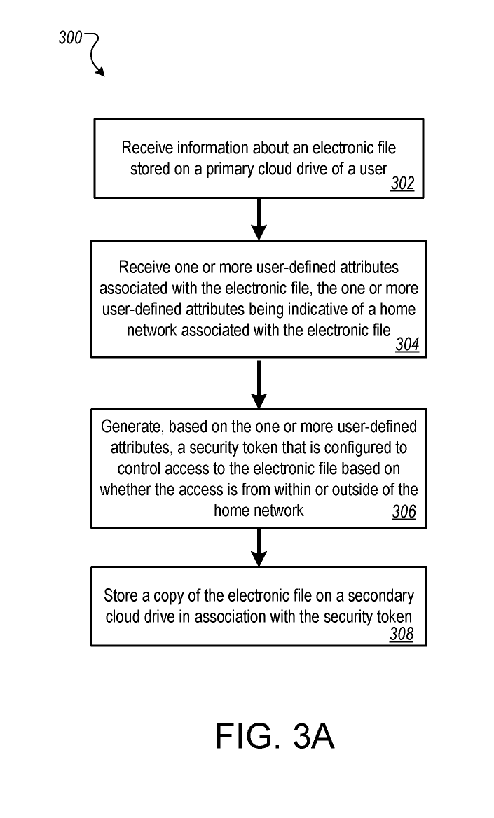

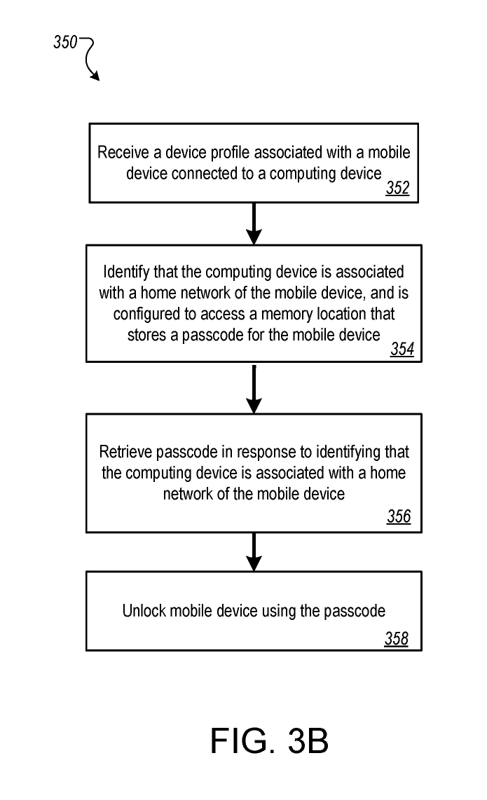

FIG. 3A shows a flowchart depicting a process 300 for securing electronic files stored in cloud drives. In some implementations, at least a portion of the operations of the process 300 can be executed, for example, at the server 106 described above with reference to FIG. 1. Operations of the process 300 includes receiving information about an electronic file stored on a primary cloud drive of the user (302). The information can include a user-input indicative of an intent to share the electronic file with one or more other users. For example, when the user intends to share or collaborate on the electronic file with one or more other users, an operating system associated with managing the user's cloud drive can be configured to initiate the process 300 such that a copy of the electronic file may be saved on a secondary cloud drive. This can include, for example, accessing an existing secondary cloud drive already hosted for the user, or launching a new secondary cloud drive (e.g., one hosted on a virtual machine).

Operations also include receiving, one or more user-defined attributes associated with the electronic file, wherein the one or more user-defined attributes are indicative of a home network associated with the electronic file (304). In some implementations, the user associated with the primary cloud drive may use the one or more user-defined attributes to specify access conditions pertaining to the electronic file being shared. For example, the user-defined attributes can include one or more of: information indicative of one or more users (e.g., specified as user-profiles) permitted to access the copy of the electronic file stored on the secondary cloud drive, information indicative of one or more devices (e.g., specified as device profiles or MAC addresses) from which the copy of the electronic file can be accessed, and a level of permitted access (e.g., read-only, read-write etc.) for the one or more users permitted to access the copy of the electronic file. In some implementations, by allowing a user to specify the user-defined attributes for the copy of the electronic file, the user may be empowered to control an encryption of the electronic file being shared with the one or more other users. In some implementations, such as within an enterprise domain, the user may select the user-defined attributes from a list of attributes approved for the domain. For example, an administrator of the enterprise domain may provide to users within the domain, a list of approved attributes (which may be specific to particular users) that they can select as the user-defined attributes for encrypting copies of files stored in their secondary cloud drives.

Operations of the process 300 further includes generating, based on the one or more user-defined attributes, a security token that is configured to control access to the electronic file based on whether the access is from within or outside of the home network (304). For example, if the user-defined attributes specify a list of user-profiles and device-profiles that are allowed to access the electronic file, the generated security token is configured to block any access attempts that do not originate from the specified user-profiles and/or device-profiles. In this example, if an access attempt is made from an unrecognized user profile or an unrecognized device, the access attempt is considered to be from outside the home network specified for the copy of the electronic file, and the security token may be configured to block such access. On the other hand, the access attempt is determined to be from within the home network when a user profile and/or a device profile associated with the access attempt is determined to be a part of the home network. In some implementations, such access control may be facilitated from a remote server (e.g., the token server 106 of FIG. 1) that receives information indicative of the attempt to access the copy of the electronic file stored on the secondary cloud drive. The security token associated with the file can be configured to provide the information to the server, which determines, based on the received information, whether the attempt is from within or outside of the home network. In accordance with the determination, the server can generate permission information that is configured to enable control of the access. The security token can be configured to control access to the document based on such permission information.

Operations of the process 300 also includes storing a copy of the electronic file on a secondary cloud drive (308). The secondary cloud drive can be a physically or logically separate storage location from the primary cloud drive. The copy of the electronic file is stored on the secondary cloud drive in association with the security token, such that the security token may control any access attempts made on the copy of the file stored on the secondary cloud drive. Storing the copy of the electronic file on the secondary cloud drive can include, for example, encrypting the copy of the electronic file based on the security token, such that the file may be decrypted when the conditions specified by the user-defined attributes are satisfied. In some implementations, storing the copy of the electronic file in association with the security token includes initiating an encapsulation of the security token with the electronic file. For example, the security token can be encapsulated with the file to generate an executable file that is launched when an access attempt on the file is made. In some implementations, the executable file can be configured to digitally destroy at least a portion of the copy of the electronic file upon detection of an access attempt from outside the home network.

During runtime, access to an electronic file can be controlled based on information received from the corresponding security token associated with the electronic file. For example, a security token can provide information on environment parameters associated with an attempt to access an electronic file. The environment parameters can include, for example, information on the access point, user profile, or security parameters associated with the electronic file. The received information may be compared to the stored information to determine whether the access attempt is considered to be from within a home network associated with the electronic file. Upon determining that the access attempt is indeed from within the home network and/or satisfies security policies associated with the corresponding electronic file, the access attempt may be authorized. This can be done, for example, by providing permission information that signals the security token to allow access to the electronic file.

In some implementations, an electronic file such as a document embedded with an environment-aware security token can be stored on a cloud drive as an encrypted document. The encryption used in storing the electronic file within the secure storage location can be based on, for example, a security key specific to a particular user. This can be used, for example, to store a user's documents within a storage system associated with a multi-user system such as a social network service or e-mail service. Access to the electronic file can be controlled, for example, based on detecting that the electronic file is stored at a storage location that is associated with the corresponding home network. In some implementations, additional layers of security can be provided, for example, by checking whether one or more of the user profile, the software application, and device profile associated with the access request is authenticated to the home network. In some implementations, access to the home network can be provided, for example, via a hyperlink (e.g., such as one embedded in an email) that is associated with an environment-aware security token. A user or device that is not otherwise associated with the home network may be able to access an electronic file within the home network using such a hyperlink. In some implementations, a user may be authenticated to the home network via an authentication request (e.g., a request for biometric authentication) that is associated with an environment-aware security token.

The security technology described in this document can be used both independently and in conjunction with other security systems and architectures. For example, the environment-aware security tokens described above can be used in conjunction with security and cryptography techniques such as biometric identification, symmetric keys, asymmetric keys, symmetric ciphers, transport layer security, and encryption techniques. For example, security for an online account that uses secure socket layer (SSL) can be increased by associating the account with a corresponding environment-aware security token to restrict editing capabilities to a user-selected set of devices. In some implementations, files (e.g., system files, data files, documents, voice files, image files, video files, or web files) stored on the home network can be stored with additional cryptography built into the security tokens utilizing for example, a symmetric key unique to a particular authorized user.

In some implementations (e.g., in high security scenarios), the environment-aware security tokens can be used in multiple layers to enhance security. For example, a file encrypted with an embedded COM object can be further encapsulated with another COM object to generate a file with double layer security. By configuring the security policies of the two COM objects differently, the security of the underlying file or document can be increased manifold. For example, the security policies can be configured such that the higher and lower layer files may be opened using two separate user profiles, thereby requiring not one, but two separate personnel to be involved in accessing the file. The encapsulation can be scalable allowing additional security to be incorporated as needed, for example, via increased layers of encapsulations.

The technology described in this document can be used to control physical or virtual access to a physical or virtual storage location. In some implementations, file system and document attributes can be used to generate environment-aware security tokens that provide access to the storage locations and/or encrypt file content. Various restrictions can be imposed based on the environment-aware security tokens. In some implementations, the environment-aware security tokens can be used to restrict user(s) or device(s) from accessing an asset. In some implementations, the environment-aware security tokens can be used in restricting documents from being copied from the original storage location. Moreover, file attributes can be configured such that corresponding environment-aware security tokens can be used to prevent unauthorized copying and/or downloading. For example, the file attributes can be controlled via the attached or embedded security tokens (e.g., embedded security objects) that are verified by a token server with or without a hardware dongle.

In some implementations, the technology described in this document may be used to provide a secure unlocking mechanism for a mobile device such as a phone or tablet device. Such a secure unlocking process may be used for unlocking a device for which a password, passcode or key is lost or unavailable. FIG. 3B shows a flowchart depicting such a process 350. In some implementations, at least portions of the process 352 are executed on a token server (e.g., the server 106 described above with reference to FIG. 1). Operations of the process includes receiving at a computing device, a device profile associated with a mobile device connected to the computing device (352). The mobile device can be connected to the computing device using a wired connection (e.g., an USB connection) or a short-range wireless connection. In some implementations, the computing device is a token server, and such short range connections can ensure that the mobile device cannot be unlocked without being physically proximate to the token server. In some cases, this may prevent the phone being unlocked from a potentially malicious and/or unauthorized entity from a remote location. The short-range wireless connections can include, for example, a connection established using at least one of: a near-field communication protocol, a Bluetooth protocol, a radio frequency identification protocol, a line-of-sight technique such as infrared communication, or another short technique that establishes that the mobile device is physically connected or proximate to at least a portion of the token server. In some implementations, the short range wireless communications may be facilitated by a hardware device (e.g., a dongle) physically attached to the mobile device. The short range communications may be made even more secure by making the establishment of such communications contingent upon execution of a secure software code on the hardware device (e.g., dongle) attached to the mobile device. The device profile provided to the token server over the wired or wireless secure connections can include, for example, a serial number of the mobile device, a GUID, an UUID, or another identifier that uniquely identifies the mobile device.

Operations of the process 350 also includes identifying, based on the device profile, that the computing device is associated with a home network of the mobile device, and is configured to access a memory location that stores a passcode for the mobile device (354). In some implementations, the computing device is a token server (e.g., the server 106), and whether or not the token server is a part of the home network for the user device depends on user-inputs received during a prior registration process. For example, a user may be asked to register the mobile device with the token server when activating the mobile device. During the registration process, the token server may obtain the device profile of the mobile device, and solicit user-permission to allow the token server to be associated with the home network of the mobile device. In some implementations, the registration process may be terminated upon receiving an indication that the user does not permit the token server to be included in the home network for the mobile device.

Operations of the process 350 also includes retrieving the passcode for the mobile device in response to identifying that the computing device is associated with a home network of the mobile device (356). The passcode can be retrieved from the memory location where it is stored during the registration process, e.g., using one or more encryption processes. For example, during the registration process, upon receiving the user permission to include the token server (or another secure computing device) in the home network for the mobile device, the token server may generate and store the passcode in a secure memory location in association with an identifier of the device profile of the mobile device. In some implementations, the passcode may be substantially the same as a user-defined passcode (e.g., a four or six-digit code set by the user to unlock the mobile device), which is obtained during the registration process. In some implementations, the passcode that is stored at the secure memory location is generated based at least in part on the user-defined passcode. In some implementations, if the user of the mobile device changes the user-defined passcode on the phone, information representing the change to the passcode may be received by the token server, and the passcode stored in the secure memory location may be updated accordingly.

In some implementations, the passcode (which may be independent of the user-defined passcode) stored at the secure memory location may be usable for automatically unlocking the mobile device when the mobile device is securely connected to the token server either via a wired connection or a secure short range wireless connection. In some implementations, the passcode stored at the secure memory location may be encrypted by an environment-aware security token such that the passcode cannot be used to unlock the mobile device from outside of the home network defined for the passcode. In some implementations, the home network for the passcode may exclude the mobile device itself. This may increase the security of the stored passcode because, for example, even if a malicious entity were to obtain the stored passcode (and decipher the associated device profile), the passcode would not be usable for unlocking the corresponding mobile device by directly providing the passcode to the mobile device as a user-input. Operations of the process 350 can also include unlocking the mobile device using the retrieved passcode (358). In some implementations, this may provide an alternative way of unlocking a mobile device, which may be made immune to human interactions with the mobile device, thereby reducing the possibilities of unauthorized access to the mobile device. Rather the technique described herein may be used only in rare and specific situations (e.g., when the user has been locked out of the mobile device for an extended time, or based on a court order requiring access to the content of the mobile device) to unlock the mobile device. In some implementations, by making such alternative unlocking possible only from a particular trusted and secure computing device (or a small group of such devices), possibilities of unintended or unauthorized uses of the technology may be reduced, or in some cases, eliminated completely.

In some implementations, the technology can be implemented as a part of an operating system (OS), such as an OS used for administering a cloud based system. For example, the security layer provided by the technology can be used to acquire control over the file management system of the corresponding OS. The technology described herein can therefore be used for implementing a user-centric operating system in which file management does not only secure the files in isolation, but includes user profiles, file identifiers, and/or device profiles in the security layer. The security layer can be used, for example, to control and verify various assets via attached, encapsulated, or embedded security objects. In some implementations, for example where a security object is encapsulated together with the corresponding file or document into a separate entity (e.g., an application or executable file), the entity can be configured to destroy, delete or otherwise digitally shred the contents of the file or document upon detecting dissociation from the home network. The dissociation can be detected, for example, when the entity fails to establish a connection with a token server that controls administration of the security objects. In some implementations, the entity can also be configured to collect information on one or more metrics associated with the environment from where an access attempt is being made. For example, in the event of a security breach (e.g., a hack), the entity can be configured to transmit details of the environment (e.g., MAC address, IP address, device serial number etc.) back to the token server. The operating system can therefore be configured such that data or files cannot be removed from a home network (or from portions thereof, e.g., a cloud drive) without appropriate permissions, for example, explicit user and/or device authorizations. The technology can therefore be configured to act as a gateway to physical and virtual storage locations on the home network or on registered devices with user(s) privileges.

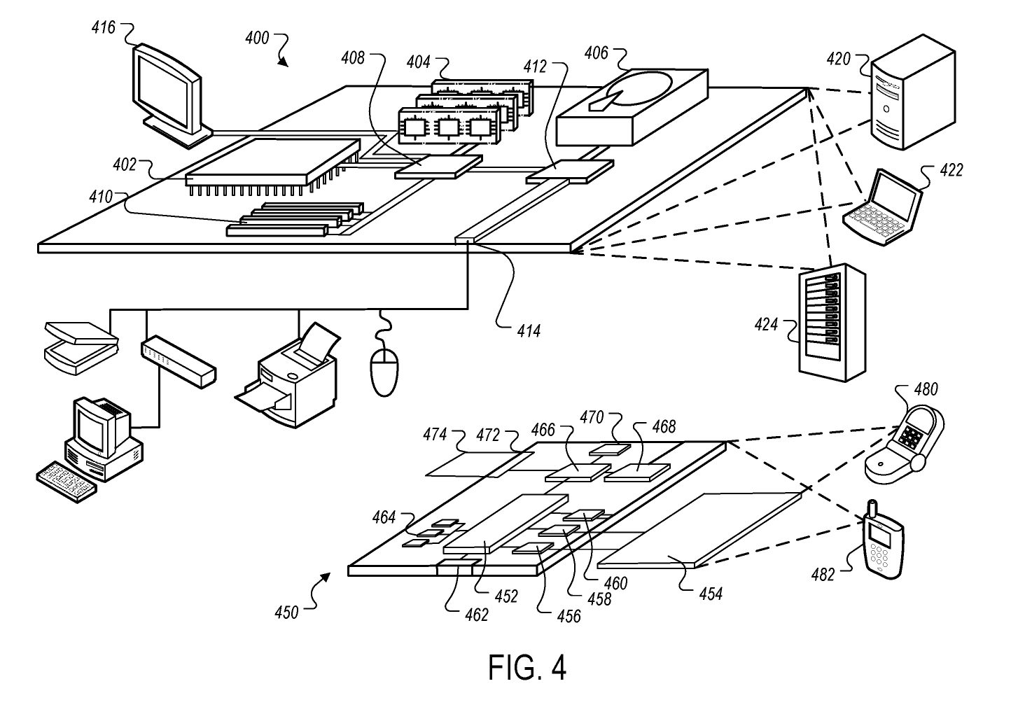

FIG. 4 shows an example of a computing device 400 and a mobile device 450, which may be used with the techniques described here. Referring to FIG. 1, any of the devices 103, 104, 106, and 125 could be examples of the computing device 400 or the mobile device 450. In some cases, the servers 106 or 125 could include one or more computing devices 400. As such, computing device 400 is intended to represent various forms of digital computers, such as laptops, desktops, workstations, personal digital assistants, servers, blade servers, mainframes, and other appropriate computers. Computing device 450 is intended to represent various forms of mobile devices, such as personal digital assistants, cellular telephones, smartphones, and other similar computing devices. The components shown here, their connections and relationships, and their functions, are meant to be examples only, and are not meant to limit implementations of the techniques described and/or claimed in this document.

The exemplary computing device 400 includes a processor 402, memory 404, a storage device 406, a high-speed interface 408 connecting to memory 404 and high-speed expansion ports 410, and a low speed interface 412 connecting to low speed bus 414 and storage device 406. Each of the components 402, 404, 406, 408, 410, and 412, are interconnected using various busses, and may be mounted on a common motherboard or in other manners as appropriate. The processor 402 can process instructions for execution within the computing device 400, including instructions stored in the memory 404 or on the storage device 406 to display graphical information for a GUI on an external input/output device, such as display 416 coupled to high speed interface 408. In other implementations, multiple processors and/or multiple buses may be used, as appropriate, along with multiple memories and types of memory. Also, multiple computing devices 400 may be connected, with each device providing portions of the necessary operations (e.g., as a server bank, a group of blade servers, or a multi-processor system). In some implementations the computing device can include a graphics processing unit. The memory 404 stores information within the computing device 400. In one implementation, the memory 404 is a volatile memory unit or units. In another implementation, the memory 404 is a non-volatile memory unit or units. The memory 404 may also be another form of computer-readable medium, such as a magnetic or optical disk.

The storage device 406 is capable of providing mass storage for the computing device 400. Referring to FIG. 1, the storage device 126 could be an example of the storage device 406. In one implementation, the storage device 406 may be or contain a non-transitory computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 404, the storage device 406, or memory on the processor 402.

The high speed controller 408 manages bandwidth-intensive operations for the computing device 400, while the low speed controller 412 manages lower bandwidth-intensive operations. Such allocation of functions is an example only. In one implementation, the high-speed controller 408 is coupled to memory 404, display 416 (e.g., through a graphics processor or accelerator), and to high-speed expansion ports 410, which may accept various expansion cards (not shown). In the implementation, low-speed controller 412 is coupled to storage device 406 and low-speed expansion port 414. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 420, or multiple times in a group of such servers. It may also be implemented as part of a rack server system 424. In addition, it may be implemented in a personal computer such as a laptop computer 422. Alternatively, components from computing device 400 may be combined with other components in a mobile device (not shown), such as device 450. Each of such devices may contain one or more of computing device 400, 450, and an entire system may be made up of multiple computing devices 400, 450 communicating with each other.

Computing device 450 includes a processor 452, memory 464, an input/output device such as a display 454, a communication interface 466, and a transceiver 468, among other components. The device 450 may also be provided with a storage device, such as a microdrive or other device, to provide additional storage. Each of the components 450, 452, 464, 454, 466, and 468, are interconnected using various buses, and several of the components may be mounted on a common motherboard or in other manners as appropriate.

The processor 452 can execute instructions within the computing device 450, including instructions stored in the memory 464. The processor may be implemented as a chipset of chips that include separate and multiple analog and digital processors. The processor may provide, for example, for coordination of the other components of the device 450, such as control of user-interfaces, applications run by device 450, and wireless communication by device 450.

Processor 452 may communicate with a user through control interface 458 and display interface 456 coupled to a display 454. The display 454 may be, for example, a TFT LCD (Thin-Film-Transistor Liquid Crystal Display) or an OLED (Organic Light Emitting Diode) display, or other appropriate display technology. The display interface 456 may comprise appropriate circuitry for driving the display 454 to present graphical and other information to a user. The control interface 458 may receive commands from a user and convert them for submission to the processor 452. In addition, an external interface 462 may be provide in communication with processor 452, so as to enable near area communication of device 450 with other devices. External interface 462 may provide, for example, for wired communication in some implementations, or for wireless communication in other implementations, and multiple interfaces may also be used.

The memory 464 stores information within the computing device 450. The memory 464 can be implemented as one or more of a computer-readable medium or media, a volatile memory unit or units, or a non-volatile memory unit or units. Expansion memory 474 may also be provided and connected to device 450 through expansion interface 472, which may include, for example, a SIMM (Single In Line Memory Module) card interface. Such expansion memory 474 may provide extra storage space for device 450, or may also store applications or other information for device 450. Specifically, expansion memory 474 may include instructions to carry out or supplement the processes described above, and may include secure information also. Thus, for example, expansion memory 474 may be provided as a security module for device 450, and may be programmed with instructions that permit secure use of device 450. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 464, expansion memory 474, memory on processor 452, or a propagated signal that may be received, for example, over transceiver 468 or external interface 462.

Device 450 may communicate wirelessly through communication interface 466, which may include digital signal processing circuitry where necessary. Communication interface 466 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 468. In addition, short-range communication may occur, such as using a Bluetooth, WiFi, or other such transceiver (not shown). In addition, GPS (Global Positioning System) receiver module 470 may provide additional navigation- and location-related wireless data to device 450, which may be used as appropriate by applications running on device 450.

Device 450 may also communicate audibly using audio codec 460, which may receive spoken information from a user and convert it to usable digital information. Audio codec 460 may likewise generate audible sound for a user, such as through a speaker, e.g., in a handset of device 450. Such sound may include sound from voice telephone calls, may include recorded sound (e.g., voice messages, music files, and so forth) and may also include sound generated by applications operating on device 450.

The computing device 450 may be implemented in a number of different forms, as shown in the figure. For example, it may be implemented as a cellular telephone 480. It may also be implemented as part of a smartphone 482, personal digital assistant, tablet computer, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well. For example, feedback provided to the user can be any form of sensory feedback (e.g., visual feedback, auditory feedback, or tactile feedback). Input from the user can be received in any form, including acoustic, speech, biometric, or tactile input.

The systems and techniques described here can be implemented in a computing system that includes a back end component (e.g., as a data server), or that includes a middleware component (e.g., an application server), or that includes a front end component (e.g., a client computer having a graphical user-interface or a Web browser through which a user can interact with an implementation of the systems and techniques described here), or any combination of such back end, middleware, or front end components. The components of the system can be interconnected by any form or medium of digital data communication (e.g., a network such as the network 102 described with reference to FIG. 1A). Examples of networks include a local area network (“LAN”), a wide area network (“WAN”), and the Internet.

The computing system can include clients and servers (including remote servers). A client and server are generally remote from each other and typically interact through a communication network such as the network 102. The relationship of client and server arises by virtue of computer programs running on the respective computers and having a client-server relationship to each other.

### APPENDIX

The attached appendix includes a document, which describes examples of entities associated with the techniques described herein. The terminology used in the appendix may differ somewhat from that used herein. In the event of a conflict in terminology, that used herein is controlling. The words used in the appendix are not meant to characterize what is claimed, but to describe the examples mentioned in the appendix.

Other implementations are also within the scope of the following claims.

1. A computer implemented method comprising:
receiving information about an electronic file stored on a primary cloud drive of a user;
receiving one or more user-defined attributes associated with the electronic file, the one or more user-defined attributes indicative of a home network associated with the electronic file;
generating, based on the one or more user-defined attributes, a security token that is configured to control access to the electronic file based on whether the access is from within or outside of the home network; and
storing a copy of the electronic file on a secondary cloud drive separate from the primary cloud drive, wherein the copy of the electronic file is stored on the secondary cloud drive in association with the security token.

2. The method of claim 1, wherein the information about the electronic file comprises a user-input indicative of an intent to share the electronic file with one or more other users.

3. The method of claim 1, wherein the one or more user-defined attributes comprise information indicative of one or more users permitted to access the copy of the electronic file.

4. The method of claim 1, wherein the one or more user-defined attributes comprise a level of permitted access for one or more users, and wherein the level of permitted access includes a read-only access or a read-write access.

5. (canceled)

6. The method of claim 1, wherein the one or more user-defined attributes comprise information indicative of one or more devices from which the copy of the electronic file can be accessed.

7. The method of claim 1, further comprising:
receiving, information indicative of an attempt to access the copy of the electronic file stored on the secondary cloud drive;
determining, based on the received information, whether the attempt is from within or outside of the home network; and
in accordance with the determination, generating permission information configured to enable control of the access.

8. The method of claim 1, further comprising:
receiving information about changes to the copy of the electronic file as a result of an attempt to access the copy of the electronic file stored on the secondary cloud drive;
presenting the changes via a user interface; and
updating the electronic file stored on the primary cloud drive upon receiving user-input indicative of an approval of the changes.

9. The method of claim 1, wherein the access is determined to be from within the home network when a user profile or a device profile associated with the access is determined to be a part of the home network.

10. The method of claim 1, wherein the access is determined to be from within the home network when a combination of a user profile and a device profile associated with the access is determined to be a part of the home network.

11. The method of claim 1, wherein storing the copy of the electronic file in association with the security token comprises initiating an encryption of the copy of the electronic file based on the security token.

12. The method of claim 11, wherein storing the copy of the electronic file in association with the security token comprises initiating an encapsulation of the security token with the electronic file, the encapsulation generating an executable file.

13. (canceled)

14. The method of claim 12, wherein the executable file is configured to digitally destroy at least a portion of the copy of the electronic file upon detection of an access attempt from outside the home network.

15. The method of claim 1, wherein the one or more user-defined attributes are selected from a set of attributes associated with an enterprise domain within which the electronic file is stored.

16.-19. (canceled)

20. A system comprising:
memory; and
one or more processing devices configured to:
receive information about an electronic file stored on a primary cloud drive of a user,
receive one or more user-defined attributes associated with the electronic file, the one or more user-defined attributes indicative of a home network associated with the electronic file,
generate, based on the one or more user-defined attributes, a security token that is configured to control access to the electronic file based on whether the access is from within or outside of the home network, and
store a copy of the electronic file on a secondary cloud drive separate from the primary cloud drive, wherein the copy of the electronic file is stored on the secondary cloud drive in association with the security token.

21. The system of claim 20, wherein the information about the electronic file comprises a user-input indicative of an intent to share the electronic file with one or more other users.

22. The system of claim 20, wherein the one or more user-defined attributes comprise information indicative of one or more users permitted to access the copy of the electronic file.

23. The system of claim 20, wherein the one or more user-defined attributes comprise a level of permitted access for one or more users, and wherein the level of permitted access includes a read-only access or a read-write access.

24. (canceled)

25. The system of claim 20, wherein the one or more user-defined attributes comprise information indicative of one or more devices from which the copy of the electronic file can be accessed.

26. The system of claim 20, wherein the one or more processing devices are further configured to:
receive, information indicative of an attempt to access the copy of the electronic file stored on the secondary cloud drive;
determine, based on the received information, whether the attempt is from within or outside of the home network; and
in accordance with the determination, generate permission information configured to enable control of the access.

27. The system of claim 20, wherein the one or more processors are further configured to:
receive information about changes to the copy of the electronic file as a result of an attempt to access the copy of the electronic file stored on the secondary cloud drive;
present the changes via a user interface; and
update the electronic file stored on the primary cloud drive upon receiving user-input indicative of an approval of the changes.

28. The system of claim 20, wherein the access is determined to be from within the home network when a user profile or a device profile associated with the access is determined to be a part of the home network.

29. The system of claim 20, wherein the access is determined to be from within the home network when a combination of a user profile and a device profile associated with the access is determined to be a part of the home network.

30. The system of claim 20, wherein storing the copy of the electronic file in association with the security token comprises initiating an encryption of the copy of the electronic file based on the security token.

31. The system of claim 30, wherein storing the copy of the electronic file in association with the security token comprises initiating an encapsulation of the security token with the electronic file, the encapsulation generating an executable file.

32. (canceled)

33. The system of claim 31, wherein the executable file is configured to digitally destroy at least a portion of the copy of the electronic file upon detection of an access attempt from outside the home network.

34. The system of claim 20, wherein the one or more user-defined attributes are selected from a set of attributes associated with an enterprise domain within which the electronic file is stored.

35. One or more machine-readable storage devices storing instructions that are executable by one or more processing devices to perform operations comprising:
obtaining information about an electronic file stored on a primary cloud drive of a user;
obtaining one or more user-defined attributes associated with the electronic file, the one or more user-defined attributes indicative of a home network associated with the electronic file;
generating, based on the one or more user-defined attributes, a security token that is configured to control access to the electronic file based on whether the access is from within or outside of the home network; and
storing a copy of the electronic file on a secondary cloud drive separate from the primary cloud drive, wherein the copy of the electronic file is stored on the secondary cloud drive in association with the security token.

36.-57. (canceled)
